(19) United States
(12) Patent Application Publication
(10) Pub. No.: US 2024/0256221 A1
(43) Pub. Date: Aug. 1, 2024

(54) FLOATING POINT ATOMICS USING INTEGER HARDWARE

(71) Applicant: QUALCOMM Incorporated, San Diego, CA (US)

(72) Inventors: Andrew Evan GRUBER, Arlington, MA (US); Alexei Vladimirovich BOURD, San Diego, CA (US)

(21) Appl. No.: 18/162,660

(22) Filed: Jan. 31, 2023

(51) Int. Cl. G06F 7/483

(52) U.S. Cl. CPC G06F 7/483

(57) ABSTRACT

This disclosure provides systems, devices, apparatus, and methods, including computer programs encoded on storage media, for floating point min/max atomics using integer hardware. A data processor may obtain a first indication of a floating point number associated with a floating point operation. The data processor may select a signed atomic integer operation or an unsigned atomic integer operation based on at least one of the floating point number or the floating point operation, where the signed atomic integer operation is associated with a condition being met and the unsigned atomic integer operation is associated with a failure of the condition to be met.

### TECHNICAL FIELD

The present disclosure relates generally to processing systems, and more particularly, to one or more techniques for data processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current hardware may not include support for floating point atomics. There is a need for improved techniques for floating point atomic support.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for data processing are provided. The apparatus includes a memory; and at least one processor coupled to the memory and, based at least in part on information stored in the memory, the at least one processor is configured to obtain a first indication of a floating point number associated with a floating point operation; and select a signed atomic integer operation or an unsigned atomic integer operation based on at least one of the floating point number or the floating point operation, where the signed atomic integer operation is associated with meeting a condition and the unsigned atomic integer operation is associated with failing to meet the condition.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 is a diagram illustrating example aspects of signed integers, unsigned integers, and floating point numbers in accordance with one or more techniques of this disclosure.

FIG. 5 is a diagram illustrating example aspects of an atomic exchange operation and an atomic compare exchange operation in accordance with one or more techniques of this disclosure.

FIG. 6 is a diagram illustrating example atomic units in a GPU in accordance with one or more techniques of this disclosure.

FIG. 7 is a diagram illustrating example aspects of an atomic maximum operation and an atomic minimum operation in accordance with one or more techniques of this disclosure.

FIG. 8 is a diagram illustrating example aspects of a floating point atomic maximum operation and a floating point atomic minimum operation in accordance with one or more techniques of this disclosure.

FIG. 9 is a call flow diagram illustrating example communications between a graphics processor and a graphics processor component in accordance with one or more techniques of this disclosure.

FIG. 10 is a flowchart of an example method of data processing in accordance with one or more techniques of this disclosure.

FIG. 11 is a flowchart of an example method of data processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Floating point atomic operations (e.g., a min/max function to emulate a depth compare with a floating point frame buffer) may be utilized by a GPU in order to facilitate the display of graphical content. For example, a GPU may be configured to access and/or modify shared data simultaneously via different threads. In an example, a first thread of the GPU may read a 32-bit integer at a first time instance and update the 32-bit integer with an incremented (or decremented) value at a second time instance occurring after the first time instance. However, a second thread of the GPU may read the 32-bit integer at a third time instance that occurs between the first time instance and the second time instance and then update the 32-bit integer with an incremented (or decremented) value at a fourth time instance, after the second time instance. As the 32-bit integer has not been updated at the third time instance, the second thread may see only the initial value of the 32-bit integer, resulting in a final value that has been incremented only once, rather than twice as was intended. To address this issue, the GPU may utilize an atomic operation so that the 32-bit integer cannot be read in between the first time instance (i.e., a time when modification of the 32-bit integer begins) and the second time instance (i.e., a time when modification of the 32-bit integer ends). The second thread may utilize an atomic operation as well so that the 32-bit integer cannot be read between the third time instance and the fourth time instance. Hence no matter what order the threads execute—the original value may be incremented twice. Some GPUs may not be configured with hardware support for floating point atomic operations. Instead, some GPUs may be configured with hardware support for signed and unsigned integer atomic operations.

Various technologies pertaining to emulating floating point atomic operations using integer hardware are described herein. In an example, an apparatus (e.g., a GPU) obtains a first indication of a floating point number associated with a floating point operation. The apparatus selects a signed atomic integer operation or an unsigned atomic integer operation based on at least one of the floating point number or the floating point operation, where the signed atomic integer operation is associated with meeting a condition and the unsigned atomic integer operation is associated with failing to meet the condition. Vis-à-vis the aforementioned features, the apparatus may emulate support for floating point maximum/minimum operations using integer hardware. Furthermore, the aforementioned features may accommodate the non-monotonicity of floating point numbers when crossing zero.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

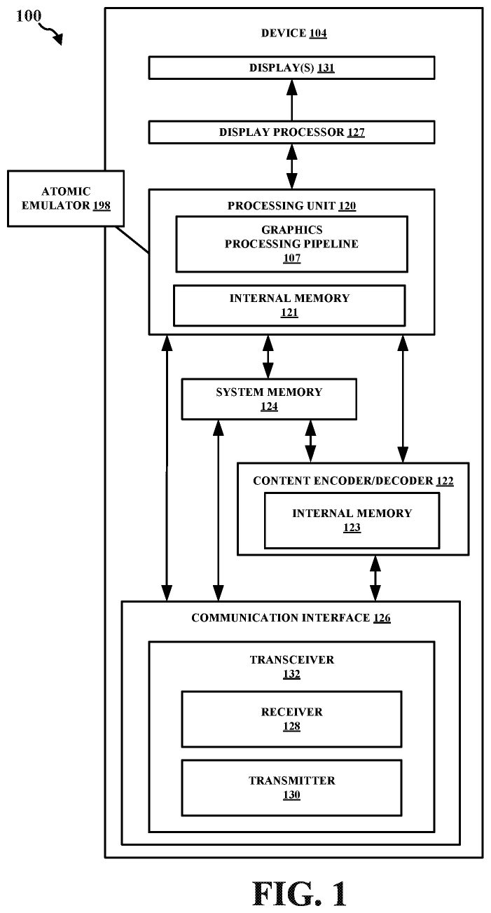

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an atomic emulator 198 configured to obtain a first indication of a floating point number associated with a floating point operation; and select a signed atomic integer operation or an unsigned atomic integer operation based on at least one of the floating point number or the floating point operation, where the signed atomic integer operation is associated with a condition being met and the unsigned atomic integer operation is associated with a failure of the condition to be met. Although the following description may be focused on data processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

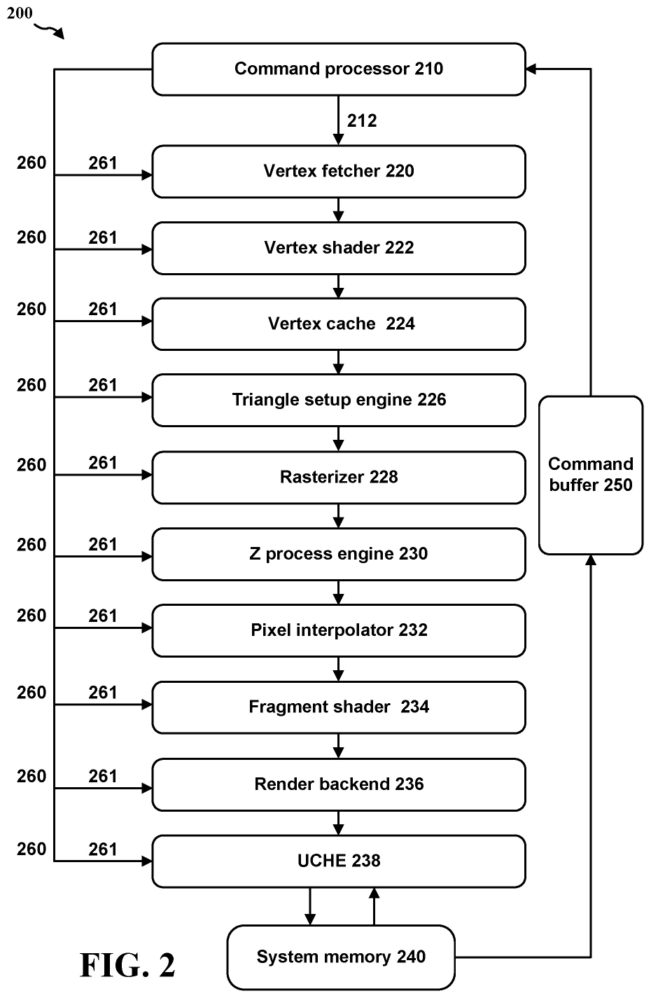

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

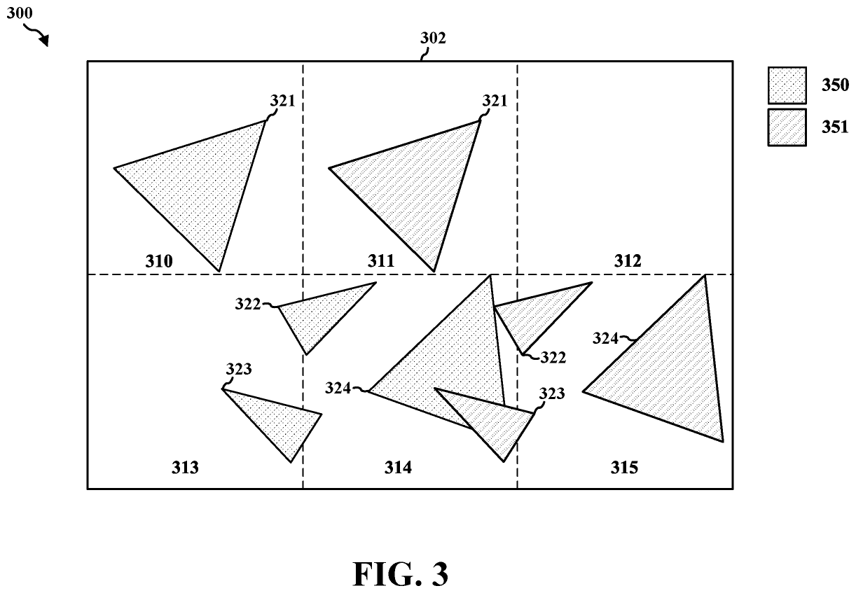

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

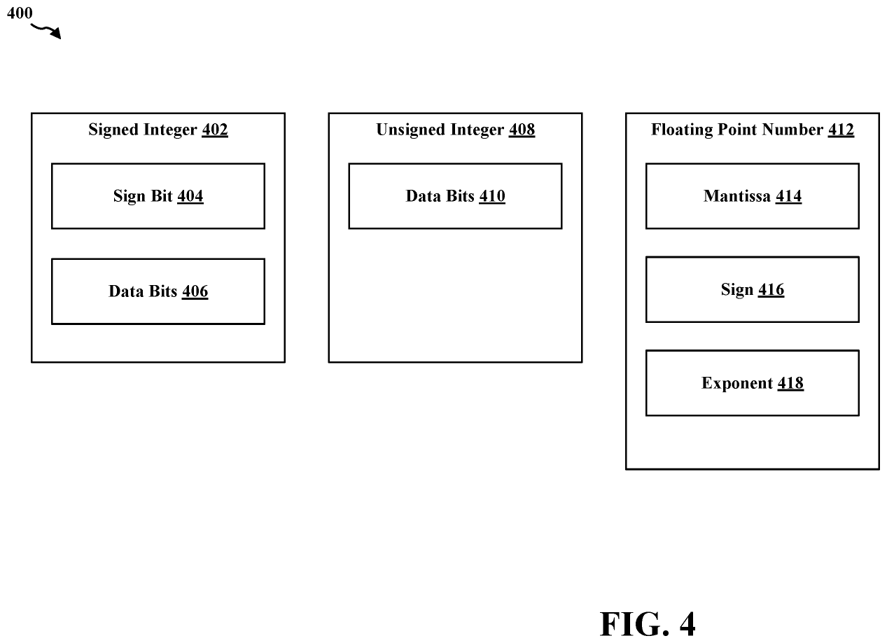

FIG. 4 is a diagram 400 illustrating example aspects of signed integers, unsigned integers, and floating point numbers. A GPU (or another device) may store data as a signed integer 402, as an unsigned integer 408, and/or as a floating point number 412. In an example, memory or a register of the GPU may store the signed integer 402, the unsigned integer 408, and/or the floating point number 412. Furthermore, hardware of the GPU may be configured to perform operations on the signed integer 402, the unsigned integer 408, and/or the floating point number 412.

The signed integer 402 may represent a negative integer, a zero integer, or a positive integer. As such, the signed integer 402 may include a sign bit 404 and data bits 406, where the sign bit 404 may indicate whether the signed integer 402 is positive or negative. For instance, the sign bit 404 may be “0” if the signed integer 402 is positive and the sign bit 404 may be “1” if the signed integer 402 is negative.

The signed integer 402 may be represented in two's complement notation. In this scheme, a positive number of bit length (n−1) may be represented by adding a “0” bit as a new most significant bit (MSB) and creating a number of bit length “n.” An equivalent negative number may be created by adding a “0” as a new MSB creating a number of bit length “n,” inverting each of the “n” bits, and adding a “1” bit to the resulting number and truncating to bit length “n.” In such a scheme, the MSB may be “0” for positive numbers and “1” for negative numbers and so the MSB may be used as the sign bit 404. In such a scheme, an encoding of the MSB of a “1” bit may be followed by “0” bits (an encoding otherwise not used) may be used to encode a negative of (2**n). A positive value of (2**n) may not be encodable.

The unsigned integer 408 may represent a zero integer or a positive integer. The unsigned integer 408 may include data bits 410 that represent the zero integer or the positive integer. In an example, the data bits 410 may include 32 bits. In the example, the data bits 410 may represent integers in the range of [0 to 4,294,967,295].

The floating point number 412 may be associated with a decimal point that is able to move (i.e., “float”). The floating point number 412 may include a mantissa 414, a sign 416, and an exponent 418. In general, the floating point number 412 may be represented by s*1.a x base^{boffset}, where s is the sign 416 (0 represents+1.0 and 1 represents −1.0), “a” is the mantissa 414, and “b” is the exponent 418. In an example, the mantissa 414 and the exponent 418 may be unsigned integer numbers, the base may be assumed to be fixed at “2” and the offset may be assumed to be fixed at “127.” In an example, +1.0*1.a x2^{b-127} may be encoded by concatenating the bits of “s,” “b,” and “a.” If “b” is “0”—then a number may represent 0.a*2⁻¹²⁷, with no leading “1” prior to “a”. This may be referred to a “denormalized’ number.” Note that if a and b are both “0”—this may represent a value of 0.0. Since “s” may still be either a “0” or “1,” in this case, both “+0.0” and “−0.0” may be encoded. In an example, the floating point number 412 may be in a range of +/−(2-2⁻²³)×2¹²⁷, which is approximately equal to +/−3.4028235×1038.

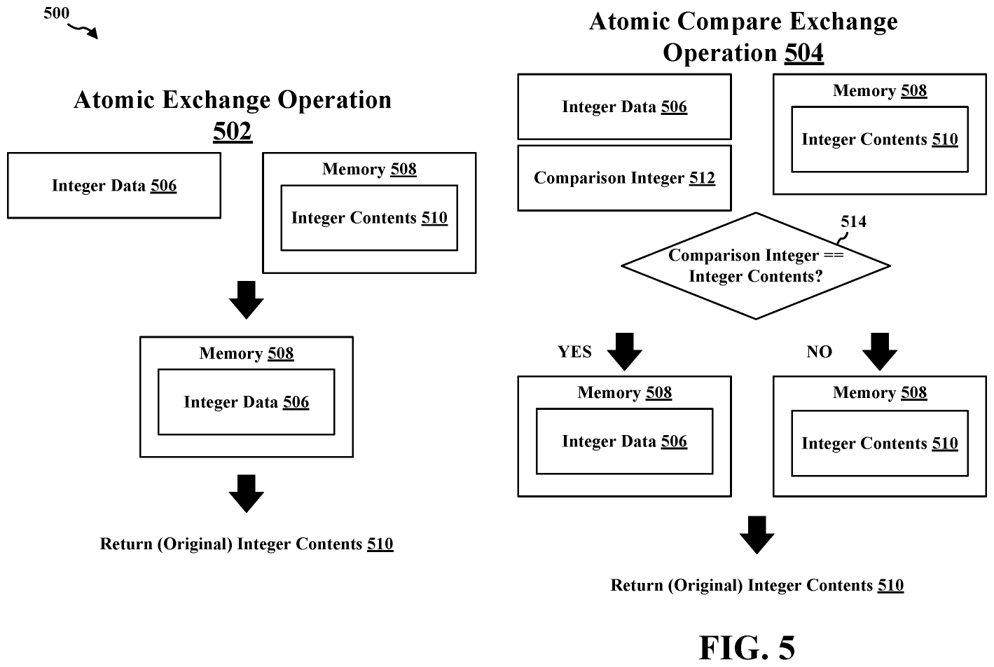

FIG. 5 is a diagram 500 illustrating example aspects of an atomic exchange operation 502 and an atomic compare exchange operation 504. A GPU (or another device) may be configured to access and/or modify shared data simultaneously via different threads. In an example, a first thread of the GPU may update (i.e., change bits) a first sixteen bits of an 32-bit integer at a first time instance and a second sixteen bits of the 32-bit integer at a second time instance occurring after the first time instance. However, a second thread of the GPU may read the 32-bit integer at a third time instance that occurs between the first time instance and the second time instance. As the 32-bit integer has not been fully updated at the third time instance, the second thread may obtain an incorrect value for the 32-bit integer.

To address the aforementioned issue, a GPU (or another device) may be configured with support for atomic operations. In general, an atomic operation may refer to an operation in which a value is read from memory, and the value is not modified by an assignment or another atomic operation between a time at which the value is read from memory and a time at which a new value is written to the memory. An atomic operation may be thread-safe. The atomic exchange operation 502 and the atomic compare exchange operation 504 may be examples of atomic operations. A GPU (or another device) may be configured with hardware support for atomic operations on integers (e.g., the signed integer 402, the unsigned integer 408, etc.); however, the GPU may not be configured with hardware support for atomic operations on floating point numbers (e.g., the floating point number 412).

In the atomic exchange operation 502, a GPU (or another device) may obtain integer data 506. Memory 508 associated with the GPU may include integer contents 510. In one example, the integer data 506 and the integer contents 510 may be signed integers (e.g., the signed integer 402). In another example, the integer data 506 and the integer contents 510 may be unsigned integers (e.g., the unsigned integer 408). In the atomic exchange operation 502, the GPU may exchange the integer data 506 with the integer contents 510 in the memory 508. More specifically, in the atomic exchange operation 502, the integer data 506 may be written into the memory 508 and the original contents of the memory 508 (i.e., the integer contents 510) are returned. The integer content 510 may not be modified by an assignment or another atomic operation in a shader invocation between a time at which the integer content 510 is read and a time at which the integer data 506 is written to the memory 508.

In the atomic compare exchange operation 504, the GPU (or another device) may obtain the integer data 506. The memory 508 associated with the GPU may include the integer contents 510. The GPU may also obtain a comparison integer 512. In one example, the integer contents 510 may be a signed integer (e.g., the signed integer 402) and the integer data 506 and the comparison integer 512 may be unsigned integers (e.g., the unsigned integer 408). In another example, the integer contents 510, the integer data 506, and the comparison integer 512 may be unsigned integers (e.g., the unsigned integer 408). In the atomic compare exchange operation 504, at 514, the GPU may compare the comparison integer 512 to the integer contents 510. If the comparison integer 512 is equal to the integer contents 510, the GPU may write the integer data 506 to the memory 508. Otherwise, the integer contents 510 may remain in the memory 508. In either case, the original contents of the memory 508 (i.e., the integer contents 510) may be returned. The integer content 510 may not be modified by an assignment or another atomic operation in a shader invocation between a time at which the integer content 510 is read and a time at which the integer data 506 is written to the memory 508.

In one aspect, a graphics processor or GPU (or another device) may utilize the atomic exchange operation 502 and the atomic compare exchange operation 504 to emulate support for floating point atomics.

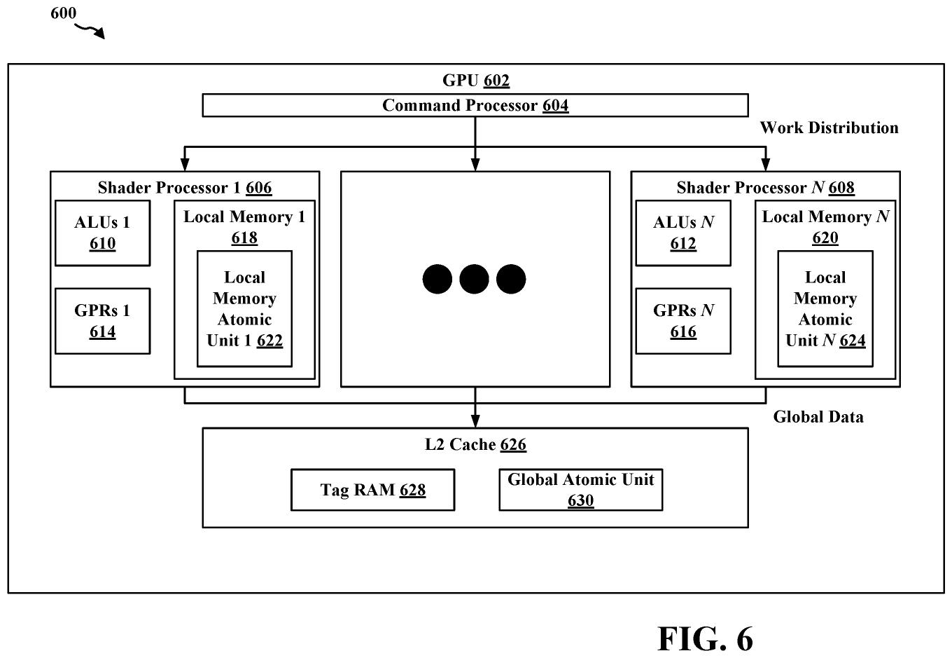

FIG. 6 is a diagram 600 illustrating example atomic units in a GPU 602 (or graphics processor). In an example, the GPU 602 may be or include the GPU 200. In an example, the GPU 602 may be included in the device 104. For instance, the GPU 602 may be the processing unit 120. The GPU 602 may include the atomic emulator 198. In an example, the GPU 602 may not include hardware support for floating point atomic operations.

The GPU 602 may include a command processor 604. The command processor 604 may receive a command and distribute work among a first shader processor 606 and an Nth shader processor 608, where Nis a positive integer greater than one, based on the command. In an example, the work may be associated with rendering of graphical content. The first shader processor 606 and the Nth shader processor 608 may collectively be referred to as “the plurality of shader processers 606-608.” The first shader processor 606 and the Nth shader processor 608 may execute shader code (e.g., vertex shaders, fragment shaders, compute shaders, etc.). The first shader processor 606 and the Nth shader processor 608 may also be referred to as shader cores. Shader code may also be referred to as a shader and may refer to a user-defined program configured to run in a stage of the GPU 602. In an example, the shader code may be associated with the rendering of graphical content.

The first shader processor 606 may include first arithmetic logic units (ALUs) 610 and the Nth shader processor 608 may include Nth ALUs 612. A number of ALUs in the first ALUs 610 may be the same as (or different from) a number of ALUs in the Nth ALUs 612. The number of ALUs in the first ALUs 610 and the number of ALUs in the Nth ALUs 612 may be a number that is different from N. The first ALUs 610 and the Nth ALUs 612 may be collectively referred to as “the plurality of ALUs 610-612.” An ALU may be a combinatorial digital circuit that performs arithmetic and bitwise operations on integer binary numbers (e.g., the signed integer 402, the unsigned integer 408, etc.).

The first shader processor 606 may include first general purpose registers (GPRs) 614 and the Nth shader processor 608 may include Nth GPRs 616. A number of GPRs in the first GPRs 614 may be the same as (or different from) a number of ALUs in the Nth GPRs 616. The number of GPRs in the first GPRs 614 and the number of GPRs in the Nth GPRs 616 may be a number that is different from N. The first GPRs 614 and the Nth GPRs 616 may be collectively referred to as “the plurality of GPRs 614-616.” A GPR may be a register that stores both data and addresses, that is, the GPR may be a combined data/address register. A register may refer to a location that may be accessed by a processor. A register may include a small amount of relatively quickly accessible storage.

The first shader processor 606 may include a first local memory 618 and the Nth shader processor 608 may include a Nth local memory 620. The first local memory 618 may include a first local memory atomic unit 622 and the Nth local memory 620 may include a Nth local memory atomic unit 624. The first local memory atomic unit 622 may perform atomic operations on data stored in the first local memory 618 and/or the first GPRs 614 and the Nth local memory atomic unit 624 may perform atomic operations on data stored in the Nth local memory 620 and/or the Nth local memory atomic unit 624. The first local memory atomic unit 622 and the Nth local memory atomic unit 624 may be hardware that does not include support for floating point atomic operations.

The GPU 602 may include a level 2 (L2) cache 626 that may be accessed by the plurality of shader processors 606-608. The L2 cache 626 may also be referred to as a unified cache. The L2 cache 626 may include Tag RAM 628. The Tag RAM 628 may identify data from other memory in cache lines of the L2 cache 626. The data itself may be stored in a part of the L2 cache 626 that is separate from the Tag RAM 628. Values stored in the Tag RAM 628 may determine whether a cache lookup results in a hit or miss. The L2 cache 626 may include a global atomic unit 630. The global atomic unit 630 may perform atomic operations on data stored in the L2 cache 626. The global atomic unit 630 may be hardware that does not include support for floating point atomic operations.

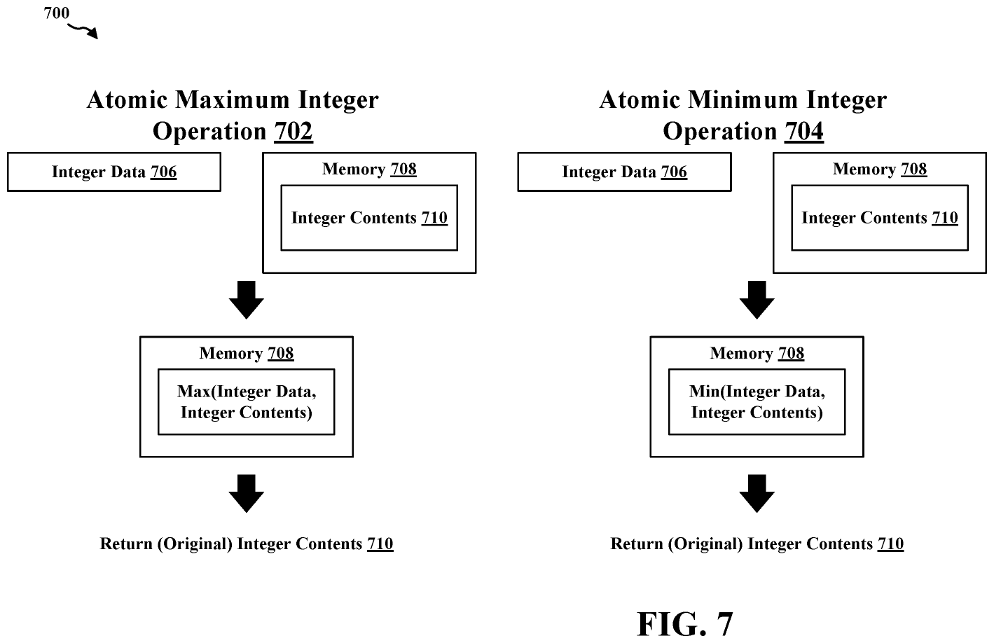

FIG. 7 is a diagram 700 illustrating example aspects of an atomic maximum integer operation 702 and an atomic minimum integer operation 704. The atomic maximum integer operation 702 may be a signed atomic integer maximum operation or an unsigned atomic integer maximum operation. The atomic minimum integer operation 704 may be a signed atomic integer minimum operation or an unsigned atomic integer minimum operation. As will be described in greater detail below, a GPU (e.g., the GPU 602 or the GPU 200) may execute the atomic maximum integer operation 702 or the atomic minimum integer operation 704 on a floating point number (or an interpreted integer generated from the floating point number) in order to emulate a floating point atomic operation, even when the GPU does not include hardware support for floating point atomic operations.

In the atomic maximum integer operation 702, a GPU or graphics processor (or a component thereof or another device) may obtain integer data 706. In an example, the first local memory atomic unit 622 may obtain the integer data 706 from the command processor 604. In another example, the global atomic unit 630 may obtain the integer data 706 from a shader processor in the plurality of shader processors 606-608. In one example, the integer data 706 may be a signed integer (e.g., the signed integer 402). In another example, the integer data 706 may be an unsigned integer (e.g., the unsigned integer 408). Memory 708 may store integer contents 710. The memory 708 may be or include the first local memory 618, the Nth local memory 620, or the L2 cache 626. In one example, the integer contents 710 maybe a signed integer (e.g., the signed integer 402). In another example, the integer contents 710 may be an unsigned integer (e.g., the unsigned integer 408). In the atomic maximum integer operation 702, the GPU or graphics processor may perform an atomic comparison of the integer data 706 to contents of the memory 708 (i.e., the integer contents 710), write the greater of the integer data 706 and the integer contents 710 to the memory 708, and return the (original) contents of the memory 708 (i.e., the integer contents 710) prior to the atomic comparison. The contents of the memory 708 (i.e., the integer contents 710) being updated during the atomic maximum integer operation 702 may not be modified by an assignment or another atomic operation in a shader invocation between a time at which the contents of the memory 708 (i.e., the integer contents 710) is read and a time at which a new value is written (e.g., either the integer data 706 or the integer contents 710).

In the atomic minimum integer operation 704, a GPU or graphics processor (or a component thereof or another device) may obtain the integer data 706. In an example, the first local memory atomic unit 622 may obtain the integer data 706 from the command processor 604. In another example, the global atomic unit 630 may obtain the integer data 706 from a shader processor in the plurality of shader processors 606-608. In one example, the integer data 706 may be a signed integer (e.g., the signed integer 402). In another example, the integer data 706 may be an unsigned integer (e.g., the unsigned integer 408). Memory 708 may store integer contents 710. In one example, the integer contents 710 may be a signed integer (e.g., the signed integer 402). In another example, the integer contents 710 may be an unsigned integer (e.g., the unsigned integer 408). In the atomic minimum integer operation 704, the GPU or graphics processor may perform an atomic comparison of the integer data 706 to contents of the memory 708 (i.e., the integer contents 710), write the lesser of the integer data 706 and the integer contents 710 to the memory 708, and return the (original) contents of the memory 708 (i.e., the integer contents 710) prior to the atomic comparison. The contents of the memory 708 (i.e., the integer contents 710) being updated during the atomic maximum integer operation 702 may not be modified by an assignment or another atomic operation in a shader invocation between a time at which the contents of the memory 708 (i.e., the integer contents 710) is read and a time at which a new value is written (either the integer data 706 or the integer contents 710).

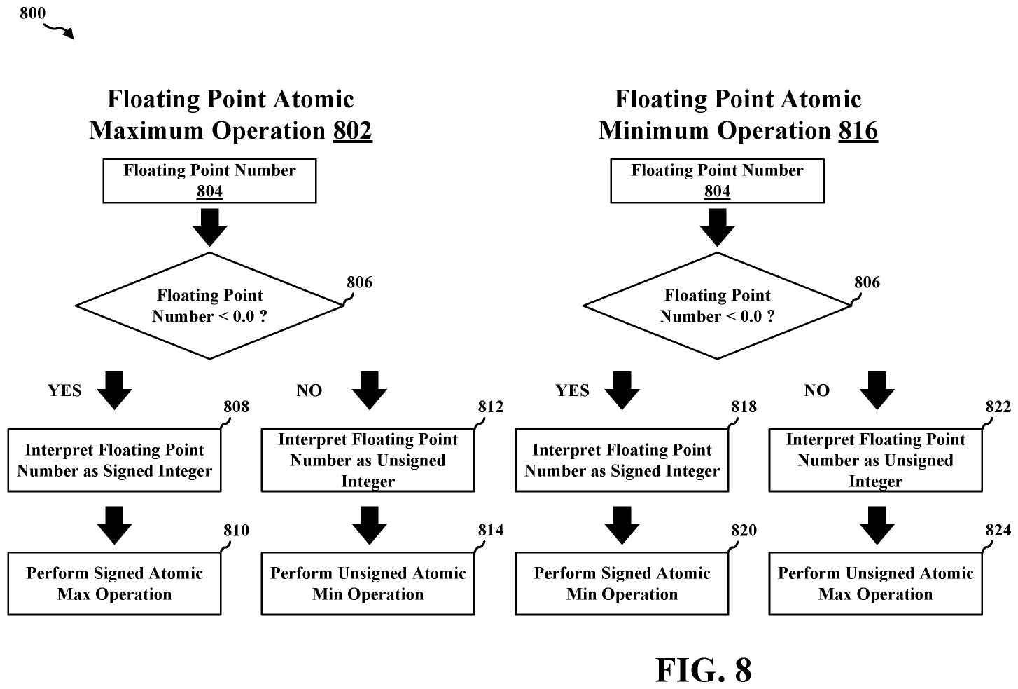

FIG. 8 is a diagram 800 illustrating example aspects of a floating point atomic maximum operation 802 and a floating point atomic minimum operation 816. A GPU or graphics processor (or a component thereof or a device) may execute the floating point atomic maximum operation 802 and/or the floating point atomic minimum operation 816. The GPU or graphics processor (or the component thereof or the device) may not include hardware that supports floating point atomic operations; however, as will be described in greater detail below, the floating point atomic maximum operation 802 and the floating point atomic minimum operation 816 may emulate support for floating point atomic operations on hardware that supports atomic integer operations. In an example, the floating point atomic maximum operation 802 and/or the floating point atomic minimum operation 816 may be performed by the first local memory atomic unit 622, the Nth local memory atomic unit 624, and/or the global atomic unit 630.

In the floating point atomic maximum operation 802, the GPU (or graphics processor) (or the component thereof or the device) may obtain a floating point number 804. In an example, the floating point number 804 may be the floating point number 412. In one example, the first local memory atomic unit 622 may obtain the floating point number 804 from the command processor 604. In another example, the global atomic unit 630 may obtain the floating point number 804 from one of the plurality of shader processors 606-608. At 806, the GPU (or graphics processor) may determine whether the floating point number 804 is less than 0.0. Stated differently, the GPU (or graphics processor) may determine whether a condition is met or not met (i.e., whether or not a failure of the condition occurs). If the floating point number 804 is less than 0.0, at 808, the GPU (or graphics processor) may interpret a floating point bit pattern of the floating point number 804 as a signed integer (e.g., the signed integer 402) and at 810, the GPU (or graphics processor) may perform a signed atomic maximum operation (e.g., the signed variant of the atomic maximum integer operation 702) on the interpreted integer (e.g., the integer data 706 may be an integer that is interpreted from the floating point bit pattern of the floating point number 804). In an example, interpreting the floating point bit pattern of the floating point number 804 as the signed integer may be performed via a union operation. If the floating point number 804 is greater than or equal to 0.0, at 812, the GPU may interpret the floating point bit pattern of the floating point number 804 as an unsigned integer (e.g., the unsigned integer 408) and at 814, the GPU (or graphics processor) may perform an unsigned atomic minimum operation (e.g., the unsigned variant of the atomic minimum integer operation 704) on the interpreted integer (e.g., the integer data 706 may be an integer that is interpreted from the floating point bit pattern of the floating point number 804). In an example, interpreting the floating point bit pattern of the floating point number 804 as the unsigned integer may be performed via a union operation.

An example of interpreting an integer from a floating point bit pattern of a floating point number is set forth below. A floating point number “1.0” maybe stored in binary format, where a hexadecimal representation of the floating point number “1.0” may be “0x3f80000.” The floating point number “1.0” may be interpreted as an integer value of “1065353216” (which is a decimal equivalent of “0x3f80000”).

The floating point atomic maximum operation 802 may be expressed in the pseudocode listed below.
FLOAT_ATOMIC_MAX: if (X<0.0) SIGNED_INT_ATOMIC_MAX(X); else UNSIGNED_INT_ATOMIC_MIN(X).

In the pseudocode listed above, “X” may be a floating point number (or an integer that is interpreted from a floating point bit pattern of the floating point number), “SIGNED_INT_ATOMIC_MAX” may refer to a signed variant of the atomic maximum integer operation 702, and “UNSIGNED_INT_ATOMIC_MIN” may refer to an unsigned variant of the atomic minimum integer operation 704.

In one aspect with respect to the pseudocode listed above, current data at an atomic location (e.g., the integer contents 710) may be “+0.0” and “X” may be “−0.0.” In such an aspect, SIGNED_INT_ATOMIC_MAX(0x80000000) may be utilized and the atomic location may be left at “+0.0” (as 0x0>0x80000000) when performing a signed integer compare. In another aspect with respect to the pseudocode listed above, current data at an atomic location (e.g., the integer contents 710) may be “−0.0” and “X” may be “+0.0.” In such an aspect UNSIGNED_INT_ATOMIC_MIN(0x0) may be utilized to correctly update the atomic location to “+0.0” (as 0x0<0x80000000) when performing an unsigned integer compare.

In the floating point atomic minimum operation 816, the GPU or graphics processor (or the component thereof or the device) may obtain the floating point number 804. In an example, the floating point number 804 may be the floating point number 412. In one example, the first local memory atomic unit 622 may obtain the floating point number 804 from the command processor 604. In another example, the global atomic unit 630 may obtain the floating point number 804 from one of the plurality of shader processors 606-608. At 806, the GPU (or graphics processor) may determine whether the floating point number 804 is less than 0.0. If the floating point number 804 is less than 0.0, at 818, the GPU (or graphics processor) may interpret a floating point bit pattern of the floating point number 804 as a signed integer (e.g., the signed integer 402) and at 820, the GPU (or graphics processor) may perform a signed atomic minimum operation (e.g., the signed variant of the atomic minimum integer operation 704) on the interpreted integer (e.g., the integer data 706 may be an integer that is interpreted from the floating point bit pattern of the floating point number 804). In an example, interpreting the floating point bit pattern of the floating point number 804 as the signed integer may be performed via a union operation. If the floating point number 804 is greater than or equal to 0.0, at 822, the GPU (or graphics processor) may interpret the floating point bit pattern of the floating point number as an unsigned integer (e.g., the unsigned integer 408) and at 824, the GPU (or graphics processor) may perform an unsigned atomic maximum operation (e.g., the unsigned variant of the atomic maximum integer operation 702) on the interpreted integer (e.g., the integer data 706 may be an integer that is interpreted from the floating point bit pattern of the floating point number 804). In an example, interpreting the floating point bit pattern of the floating point number 804 as the unsigned integer may be performed via a union operation.

The floating point atomic minimum operation 816 may be expressed in the pseudocode listed below.
FLOAT_ATOMIC_MIN: if (X<0.0) SIGNED_INT_ATOMIC_MIN(X); else UNSIGNED_INT_ATOMIC_MAX(X).

In the pseudocode listed above, “X” may be a floating point number (or an integer that is interpreted from a floating point bit pattern of the floating point number), “SIGNED_INT_ATOMIC_MIN” may refer to a signed variant of the atomic minimum integer operation 704, and “UNSIGNED_INT_ATOMIC_MAX” may refer to an unsigned variant of the atomic maximum integer operation 702.

The GPU (or graphics processor) may utilize results of the floating point atomic maximum operation 802 and/or the floating point atomic minimum operation 816 for further processing steps associated with rendering of graphical data (or for other purposes. In one example, the GPU may utilize the floating point number 804 in an operation that is dependent on the floating point number 804 being greater than a certain value or less than a certain value stored in memory or a register of the GPU. In another example, the GPU may utilize a value written to the memory 708 (e.g., an integer interpreted from a floating point bit pattern of the floating point number 804) for subsequent processing.

In one aspect, the GPU may utilize the atomic exchange operation 502 and the atomic compare exchange operation 504 to emulate floating point maximum/minimum atomic operations on integer hardware. The floating point atomic maximum operation 802 and the floating point atomic minimum operation 816 may be more computationally efficient in comparison to the atomic exchange operation 502 and the atomic compare exchange operation 504 for purposes of emulating floating point maximum/minimum operations on integer hardware.

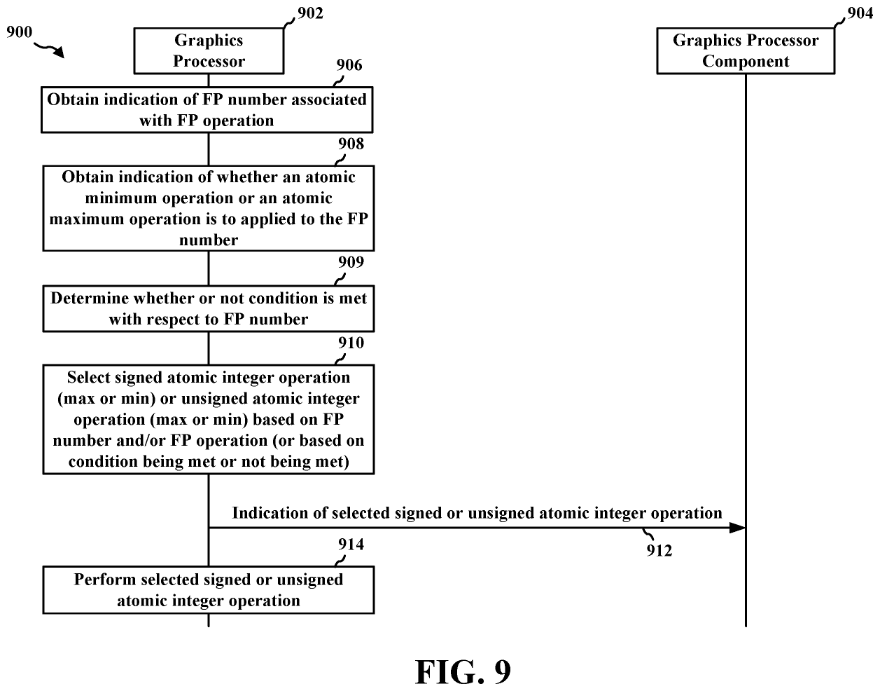

FIG. 9 is a call flow diagram 900 illustrating example communications between a graphics processor 902 and a graphics processor component 904 in accordance with one or more techniques of this disclosure. In an example, the graphics processor 902 and/or the graphics processor component 904 may be or include the GPU 200 or the GPU 602. In another example, the graphics processor 902 and/or the graphics processor component 904 may be included in the device 104. In an example, the graphics processor 902 and the graphics processor component 904 may not include hardware support for floating point atomic operations.

At 906, the graphics processor 902 may obtain an indication of a floating point (FP) number associated with a FP operation. In an example, the FP number may be the floating point number 412. At 908, the graphics processor 902 may obtain an indication of whether an atomic minimum operation or an atomic maximum operation is to be applied to the FP number. In an example, the indication may be an indication of the floating point atomic maximum operation 802 or an indication of the floating point atomic minimum operation 816. At 909, the graphics processor 902 may determine whether or not a condition is met with respect to the FP number. In an example, the condition may be met if the FP number is less than 0.0 and the condition may not be met if the FP number is greater than or equal to 0.0.

At 910, the graphics processor 902 may select a signed atomic integer operation or an unsigned atomic integer operation based on the FP number and/or the FP operation. For example, the graphics processor 902 may select the signed atomic integer operation if the FP number is less than 0.0 or the graphics processor 902 may select the unsigned atomic integer operation if the FP number is greater than or equal to 0.0. At 912, the graphics processor 902 may transmit an indication of the selected signed atomic integer operation or the unsigned atomic integer operation to the graphics processor component 904. At 914, the graphics processor 902 may perform the selected signed atomic integer operation or unsigned atomic integer operation as described above in the description of FIG. 8.

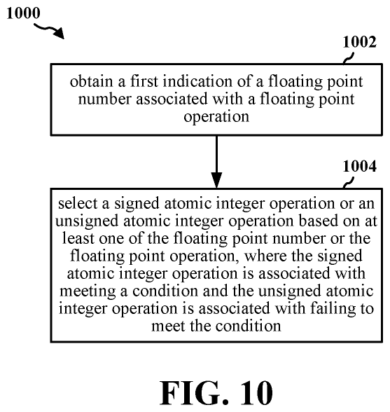

FIG. 10 is a flowchart 1000 of an example method of data processing in accordance with one or more techniques of this disclosure. The method may be performed by an apparatus, such as an apparatus for graphics processing, a graphics processor (e.g., a GPU), a CPU, a wireless communication device, and the like, as used in connection with the aspects of FIGS. 1-9. The method may be associated with various technical advantages at the graphics processor, such as emulating floating point atomic operations on hardware that supports integer atomic operations and not floating point atomic operations. In an example, the method may be performed by the atomic emulator 198.

At 1002, the apparatus (e.g., a graphics processor) may obtain a first indication of a floating point number associated with a floating point operation. For example, FIG. 9 at 906 shows that the graphics processor 902 may obtain an indication of a FP number associated with a FP operation. In an example, the floating point number may be the floating point number 412. In a further example, the floating point number may be the floating point number 804. In another example, the floating point operation may be a maximum operation or a minimum operation. In an example, 1002 may be performed by the atomic emulator 198.

At 1004, the apparatus (e.g., a graphics processor) selects a signed atomic integer operation or an unsigned atomic integer operation based on at least one of the floating point number or the floating point operation, where the signed atomic integer operation is associated with meeting a condition and the unsigned atomic integer operation is associated with failing to meet the condition. For example, FIG. 9 at 910 shows that the graphics processor 902 may select a signed atomic integer operation or an unsigned atomic integer operation based on a FP number and/or a FP operation. In an example, the signed atomic integer operation may be a signed version of the atomic maximum integer operation 702 or a signed version of the atomic minimum integer operation 704. In an example, the unsigned atomic integer operation may be an unsigned version of the atomic maximum integer operation 702 or an unsigned version of the atomic minimum integer operation 704. In an example, the condition being met may include the floating point number being less than a number (e.g., 0.0) and the condition not being met may include the floating point number being greater than or equal to the number. In a further example, selecting the signed atomic integer operation or the unsigned atomic integer operation may include aspects described above with respect to FIG. 8. In an example, 1004 may be performed by the atomic emulator 198.

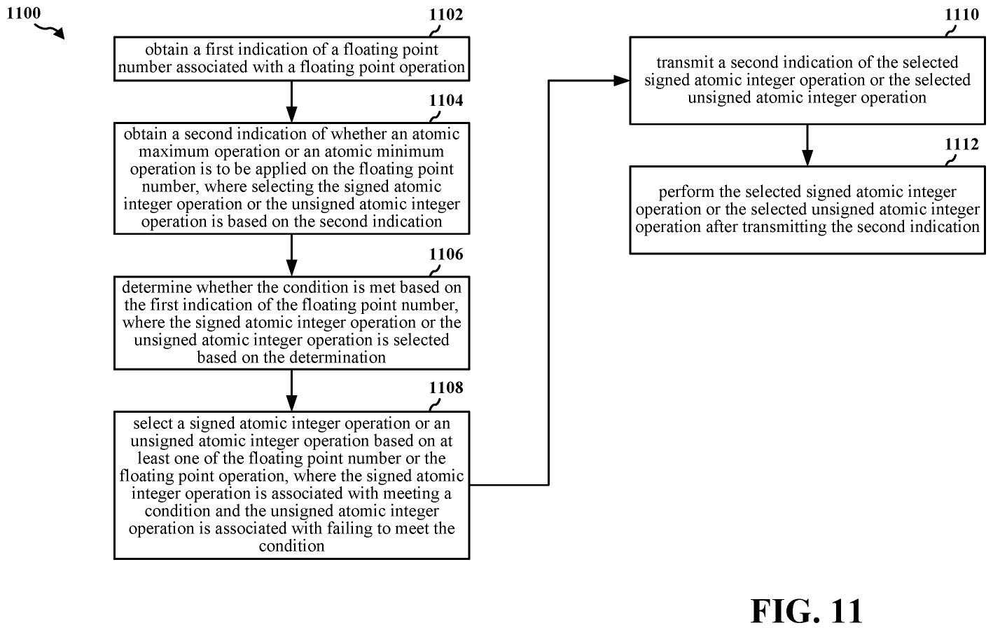

FIG. 11 is a flowchart 1100 of an example method of data processing in accordance with one or more techniques of this disclosure. The method may be performed by an apparatus, such as an apparatus for graphics processing, a graphics processor (e.g., a GPU), a CPU, a wireless communication device, and the like, as used in connection with the aspects of FIGS. 1-9. The method may be associated with various technical advantages at the graphics processor, such as emulating floating point atomic operations on hardware that supports integer atomic operations and not floating point atomic operations. In an example, the method (including the various aspects detailed below) may be performed by the atomic emulator 198.

At 1102, the apparatus (e.g., a graphics processor) obtains a first indication of a floating point number associated with a floating point operation. For example, FIG. 9 at 906 shows that the graphics processor 902 may obtain an indication of a FP number associated with a FP operation. In an example, the floating point number may be the floating point number 412. In a further example, the floating point number may be the floating point number 804. In another example, the floating point operation may be a maximum operation or a minimum operation. In an example, 1102 may be performed by the atomic emulator 198.

At 1108, the apparatus (e.g., a graphics processor) selects a signed atomic integer operation or an unsigned atomic integer operation based on at least one of the floating point number or the floating point operation, where the signed atomic integer operation is associated with meeting a condition and the unsigned atomic integer operation is associated with failing to meet the condition. For example, FIG. 9 at 910 shows that the graphics processor 902 may select a signed atomic integer operation or an unsigned atomic integer operation based on a FP number and/or a FP operation. In an example, the signed atomic integer operation may be a signed version of the atomic maximum integer operation 702 or a signed version of the atomic minimum integer operation 704. In an example, the unsigned atomic integer operation may be an unsigned version of the atomic maximum integer operation 702 or an unsigned version of the atomic minimum integer operation 704. In an example, the condition being met may include the floating point number being less than a number (e.g., 0.0) and the condition not being met may include the floating point number being greater than or equal to the number. In a further example, selecting the signed atomic integer operation or the unsigned atomic integer operation may include aspects described above with respect to FIG. 8. In an example, 1108 may be performed by the atomic emulator 198.

In one aspect, at 1110, the apparatus (e.g., a graphics processor) may transmit a second indication of the selected signed atomic integer operation or the selected unsigned atomic integer operation. For example, FIG. 9 at 912 shows that the graphics processor 902 may transmit an indication of a selected signed or unsigned atomic integer operation to a graphics processor component 904. In an example, 1110 may be performed by the atomic emulator 198.

In one aspect, at 1112, the apparatus (e.g., a graphics processor) may perform the selected signed atomic integer operation or the selected unsigned atomic integer operation after transmitting the second indication. For example, FIG. 9 at 914 shows that the graphics processor 902 may perform the selected signed or unsigned atomic integer operation after transmitting the indication of the selected signed or unsigned integer operation at 912. In an example, 1112 may be performed by the atomic emulator 198.

In one aspect, the selected signed atomic integer operation or the selected unsigned atomic integer operation may be associated with at least one compare exchange operation. For example, the selected signed atomic integer operation or the selected unsigned atomic integer operation may be associated with the atomic compare exchange operation 504 or the atomic exchange operation 502.

In one aspect, the selected signed atomic integer operation or the selected unsigned atomic integer operation may correspond to a one-to-one replacement of the floating point operation. For example, the selected signed atomic integer operation or the selected unsigned atomic integer operation may correspond to a one-to-one replacement of a maximum or a minimum floating point operation.

In one aspect, at 1106, the apparatus (e.g., a graphics processor) may determine whether the condition is met based on the first indication of the floating point number, and the signed atomic integer operation or the unsigned atomic integer operation may be selected based on the determination. For example, FIG. 9 at 909 shows that the graphics processor 902 may determine whether or not a condition is met with respect to the FP number. Furthermore, FIG. 9 at 910 shows that selecting the signed atomic integer operation or the unsigned atomic integer operation may be based on the condition being met or not being met. In an example, 1106 may be performed by the atomic emulator 198.

In one aspect, the condition may be met if the floating point number is less than 0.0, and the condition may fail to be met if the floating point number is greater than or equal to 0.0. For example, the condition at 909 may include the FP number being less than 0.0. In another example, the condition may include aspects described above with respect to 806 in FIG. 8.

In one aspect, at 1104, the apparatus (e.g., a graphics processor) may obtain a second indication of whether an atomic maximum operation or an atomic minimum operation is to be applied on the floating point number, where selecting the signed atomic integer operation or the unsigned atomic integer operation may be based on the second indication. For example, FIG. 9 at 908 shows that the graphics processor 902 may obtain an indication of whether an atomic minimum operation or an atomic maximum operation is to be applied to the FP number. In an example, the atomic maximum operation may be the floating point atomic maximum operation 802 and the atomic minimum operation may be the floating point atomic minimum operation 816. Furthermore, the signed atomic integer operation or the unsigned atomic integer operation selected at 910 may be a maximum operation or a minimum operation. In an example, 1104 may be performed by the atomic emulator 198.

In one aspect, the second indication may indicate that the atomic maximum operation is to be applied on the floating point number, and selecting the signed atomic integer operation may include applying a signed atomic integer maximum operation on the floating point number. For example, the second indication may indicate that the floating point atomic maximum operation 802 is to be applied to the floating point number 804. Furthermore, selecting the signed atomic integer operation may include aspects described above with respect to 810 in FIG. 8. Furthermore, applying the signed atomic integer maximum operation on the floating point number may include applying a signed version of the atomic maximum integer operation 702.

In one aspect, the second indication may indicate that the atomic maximum operation is to be applied on the floating point number, and selecting the unsigned atomic integer operation may include applying an unsigned atomic integer minimum operation on the floating point number. For example, the second indication may indicate that the floating point atomic maximum operation 802 is to be applied to the floating point number 804. Furthermore, selecting the unsigned atomic integer operation may include aspects described above with respect to 814 in FIG. 8. Furthermore, applying the unsigned atomic integer minimum operation on the floating point number may include applying an unsigned version of the atomic minimum integer operation 704.

In one aspect, the second indication may indicate that the atomic minimum operation is to be applied on the floating point number, and selecting the signed atomic integer operation may include applying a signed atomic integer minimum operation on the floating point number. For example, the second indication may indicate that the floating point atomic minimum operation 816 is to be applied to the floating point number 804. Furthermore, selecting the signed atomic integer operation may include aspects described above with respect to 820 in FIG. 8. Furthermore, applying the signed atomic integer minimum operation on the floating point number may include applying a signed version of the atomic minimum integer operation 704.

In one aspect, the second indication may indicate that the atomic minimum operation is to be applied on the floating point number, and selecting the unsigned atomic integer operation may include applying an unsigned atomic integer maximum operation on the floating point number. For example, the second indication may indicate that the floating point atomic minimum operation 816 is to be applied to the floating point number 804. Furthermore, selecting the unsigned atomic integer operation may include aspects described above with respect to 824 in FIG. 8. Furthermore, applying the unsigned atomic integer maximum operation on the floating point number may include applying an unsigned version of the atomic maximum integer operation 702.

In one aspect, the signed atomic integer operation or the unsigned atomic integer operation may be associated with shader code at a graphics processor. For example, the signed atomic integer operation or the unsigned atomic integer operation may be associated with code associated with the plurality of shader processers 606-608 of the GPU 602.

In one aspect, the signed atomic integer operation or the unsigned atomic integer operation may be associated with a L2 cache at a graphics processor. For example, the signed atomic integer operation or the unsigned atomic integer operation may be associated with the L2 cache 626 of the GPU 602.

In one aspect, the signed atomic integer operation or the unsigned atomic integer operation may be associated with at least one thread at a graphics processor. For example, the signed atomic integer operation or the unsigned atomic integer operation may be associated with thread(s) associated with the GPU 602.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a first indication of a floating point number associated with a floating point operation. The apparatus may further include means for selecting a signed atomic integer operation or an unsigned atomic integer operation based on at least one of the floating point number or the floating point operation, where the signed atomic integer operation is associated with meeting a condition and the unsigned atomic integer operation is associated with failing to meet the condition. The apparatus may further include means for transmitting a second indication of the selected signed atomic integer operation or the selected unsigned atomic integer operation. The apparatus may further include means for performing the selected signed atomic integer operation or the selected unsigned atomic integer operation after transmitting the second indication. The apparatus may further include means for determining whether the condition is met based on the first indication of the floating point number, where the signed atomic integer operation or the unsigned atomic integer operation is selected based on the determination. The apparatus may further include means for obtaining a second indication of whether an atomic maximum operation or an atomic minimum operation is to be applied on the floating point number, where selecting the signed atomic integer operation or the unsigned atomic integer operation is based on the second indication.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of data processing, including: obtaining a first indication of a floating point number associated with a floating point operation; and selecting a signed atomic integer operation or an unsigned atomic integer operation based on at least one of the floating point number or the floating point operation, where the signed atomic integer operation is associated with meeting a condition and the unsigned atomic integer operation is associated with failing to meet the condition.

Aspect 2 may be combined with aspect 1 and further includes transmitting a second indication of the selected signed atomic integer operation or the selected unsigned atomic integer operation.

Aspect 3 may be combined with aspect 2 and further includes performing the selected signed atomic integer operation or the selected unsigned atomic integer operation after transmitting the second indication.

Aspect 4 may be combined with any of aspects 1-3 and includes that the selected signed atomic integer operation or the selected unsigned atomic integer operation is associated with at least one compare exchange operation.

Aspect 5 may be combined with any of aspects 1-4 and includes that the selected signed atomic integer operation or the selected unsigned atomic integer operation corresponds to a one-to-one replacement of the floating point operation.

Aspect 6 may be combined with any of aspects 1-5 and further includes determining whether the condition is met based on the first indication of the floating point number, where the signed atomic integer operation or the unsigned atomic integer operation is selected based on the determination.

Aspect 7 may be combined with aspect 6 and includes that the condition is met if the floating point number is less than 0.0, and includes that the condition fails to be met if the floating point number is greater than or equal to 0.0.

Aspect 8 may be combined with any of aspects 1-7 and further includes obtaining a second indication of whether an atomic maximum operation or an atomic minimum operation is to be applied on the floating point number, where selecting the signed atomic integer operation or the unsigned atomic integer operation is based on the second indication.

Aspect 9 may be combined with aspect 8 and includes that the second indication indicates that the atomic maximum operation is to be applied on the floating point number, where selecting the signed atomic integer operation includes applying a signed atomic integer maximum operation on the floating point number.

Aspect 10 may be combined with aspect 8 and includes that the second indication indicates that the atomic maximum operation is to be applied on the floating point number, where selecting the unsigned atomic integer operation includes applying an unsigned atomic integer minimum operation on the floating point number.

Aspect 11 may be combined with aspect 8 and includes that the second indication indicates that the atomic minimum operation is to be applied on the floating point number, where selecting the signed atomic integer operation includes applying a signed atomic integer minimum operation on the floating point number.

Aspect 12 may be combined with aspect 8 and includes that the second indication indicates that the atomic minimum operation is to be applied on the floating point number, where selecting the unsigned atomic integer operation includes applying an unsigned atomic integer maximum operation on the floating point number.

Aspect 13 may be combined with any of aspects 1-12 and includes that the signed atomic integer operation or the unsigned atomic integer operation is associated with shader code at a graphics processor.

Aspect 14 may be combined with any of aspects 1-13 and includes that the signed atomic integer operation or the unsigned atomic integer operation is associated with a level 2 (L2) cache at a graphics processor.

Aspect 15 may be combined with any of aspects 1-14 and includes that the signed atomic integer operation or the unsigned atomic integer operation is associated with at least one thread at a graphics processor.

Aspect 16 is an apparatus for data processing including at least one processor coupled to a memory and configured to implement a method as in any of aspects 1-15.

Aspect 17 may be combined with aspect 16 and includes that the apparatus is a wireless communication device including at least one of a transceiver or an antenna coupled to the at least one processor, where to obtain the first indication, the at least one processor is configured to obtain the first indication via at least one of the transceiver or the antenna.

Aspect 18 is an apparatus for data processing including means for implementing a method as in any of aspects 1-15.

Aspect 19 is a computer-readable medium (e.g., a non-transitory computer-readable medium) storing computer executable code, the computer executable code when executed by at least one processor causes the at least one processor to implement a method as in any of aspects 1-15.

Various aspects have been described herein. These and other aspects are within the scope of the following claims.

What is claimed is:

1. An apparatus for data processing, comprising:
a memory; and
at least one processor coupled to the memory and, based at least in part on information stored in the memory, the at least one processor is configured to:
obtain a first indication of a floating point number associated with a floating point operation; and
select a signed atomic integer operation or an unsigned atomic integer operation based on at least one of the floating point number or the floating point operation, wherein the signed atomic integer operation is associated with a condition being met and the unsigned atomic integer operation is associated with a failure of the condition to be met.

2. The apparatus of claim 1, wherein the at least one processor is further configured to:
transmit a second indication of the selected signed atomic integer operation or the selected unsigned atomic integer operation.

3. The apparatus of claim 2, wherein the at least one processor is further configured to:
perform the selected signed atomic integer operation or the selected unsigned atomic integer operation after the at least one processor is configured to transmit the second indication.

4. The apparatus of claim 1, wherein the selected signed atomic integer operation or the selected unsigned atomic integer operation is associated with at least one compare exchange operation.

5. The apparatus of claim 1, wherein the selected signed atomic integer operation or the selected unsigned atomic integer operation corresponds to a one-to-one replacement of the floating point operation.

6. The apparatus of claim 1, wherein the at least one processor is further configured to:
determine whether the condition is met based on the first indication of the floating point number, wherein to select the signed atomic integer operation or the unsigned atomic integer operation, the at least one processor is configured to select the signed atomic integer operation or the unsigned atomic integer operation based on the determination.

7. The apparatus of claim 6, wherein the condition is met if the floating point number is less than 0.0, and wherein the condition fails to be met if the floating point number is greater than or equal to 0.0.

8. The apparatus of claim 1, wherein the at least one processor is further configured to:
obtain a second indication of whether an atomic maximum operation or an atomic minimum operation is to be applied on the floating point number, wherein to select the signed atomic integer operation or the unsigned atomic integer operation, the at least one processor is configured to select the signed atomic integer operation or the unsigned atomic integer operation based on the second indication.

9. The apparatus of claim 8, wherein the second indication indicates that the atomic maximum operation is to be applied on the floating point number, wherein to select the signed atomic integer operation, the at least one processor is configured to apply a signed atomic integer maximum operation on the floating point number.

10. The apparatus of claim 8, wherein the second indication indicates that the atomic maximum operation is to be applied on the floating point number, wherein to select the unsigned atomic integer operation, the at least one processor is configured to apply an unsigned atomic integer minimum operation on the floating point number.

11. The apparatus of claim 8, wherein the second indication indicates that the atomic minimum operation is to be applied on the floating point number, wherein to select the signed atomic integer operation, the at least one processor is configured to apply a signed atomic integer minimum operation on the floating point number.

12. The apparatus of claim 8, wherein the second indication indicates that the atomic minimum operation is to be applied on the floating point number, wherein to select the unsigned atomic integer operation, the at least one processor is configured to apply an unsigned atomic integer maximum operation on the floating point number.

13. The apparatus of claim 1, wherein the signed atomic integer operation or the unsigned atomic integer operation is associated with shader code at a graphics processor.

14. The apparatus of claim 1, wherein the signed atomic integer operation or the unsigned atomic integer operation is associated with a level 2 (L2) cache at a graphics processor.

15. The apparatus of claim 1, wherein the signed atomic integer operation or the unsigned atomic integer operation is associated with at least one thread at a graphics processor.

16. The apparatus of claim 1, wherein the apparatus is a wireless communication device comprising at least one of a transceiver or an antenna coupled to the at least one processor, wherein to obtain the first indication, the at least one processor is configured to obtain the first indication via at least one of the transceiver or the antenna.

17. A method of data processing, comprising:
obtaining a first indication of a floating point number associated with a floating point operation; and
selecting a signed atomic integer operation or an unsigned atomic integer operation based on at least one of the floating point number or the floating point operation, wherein the signed atomic integer operation is associated with meeting a condition and the unsigned atomic integer operation is associated with failing to meet the condition.

18. The method of claim 17, further comprising:
transmitting a second indication of the selected signed atomic integer operation or the selected unsigned atomic integer operation.

19. The method of claim 18, further comprising:
performing the selected signed atomic integer operation or the selected unsigned atomic integer operation after transmitting the second indication.

20. The method of claim 17, wherein the selected signed atomic integer operation or the selected unsigned atomic integer operation is associated with at least one compare exchange operation.

21. The method of claim 17, wherein the selected signed atomic integer operation or the selected unsigned atomic integer operation corresponds to a one-to-one replacement of the floating point operation.

22. The method of claim 17, further comprising:
determining whether the condition is met based on the first indication of the floating point number, wherein the signed atomic integer operation or the unsigned atomic integer operation is selected based on the determination.

23. The method of claim 22, wherein the condition is met if the floating point number is less than 0.0, and wherein the condition fails to be met if the floating point number is greater than or equal to 0.0.

24. The method of claim 17, further comprising:
obtaining a second indication of whether an atomic maximum operation or an atomic minimum operation is to be applied on the floating point number, wherein selecting the signed atomic integer operation or the unsigned atomic integer operation is based on the second indication.

25. The method of claim 24, wherein the second indication indicates that the atomic maximum operation is to be applied on the floating point number, wherein selecting the signed atomic integer operation comprises applying a signed atomic integer maximum operation on the floating point number.

26. The method of claim 24, wherein the second indication indicates that the atomic maximum operation is to be applied on the floating point number, wherein selecting the unsigned atomic integer operation comprises applying an unsigned atomic integer minimum operation on the floating point number.

27. The method of claim 24, wherein the second indication indicates that the atomic minimum operation is to be applied on the floating point number, wherein selecting the signed atomic integer operation comprises applying a signed atomic integer minimum operation on the floating point number.

28. The method of claim 24, wherein the second indication indicates that the atomic minimum operation is to be applied on the floating point number, wherein selecting the unsigned atomic integer operation comprises applying an unsigned atomic integer maximum operation on the floating point number.

29. The method of claim 17, wherein the signed atomic integer operation or the unsigned atomic integer operation is associated with shader code at a graphics processor.

30. A computer-readable medium storing computer executable code, the computer executable code when executed by at least one processor causes the at least one processor to:
obtain a first indication of a floating point number associated with a floating point operation; and
select a signed atomic integer operation or an unsigned atomic integer operation based on at least one of the floating point number or the floating point operation, wherein the signed atomic integer operation is associated with a condition being met and the unsigned atomic integer operation is associated with a failure of the condition to be met.
